(19) United States
(12) Patent Application Publication
(10) Pub. No.: US 2024/0165848 A1
(43) Pub. Date: May 23, 2024

(54) PRESSED CERAMIC FLUIDIC MODULE WITH POROUS AND NON-POROUS STRUCTURES

(71) Applicant: CORNING INCORPORATED, CORNING, NY (US)

(72) Inventors: William Joseph Bouton, Big Flats, NY (US); Alexander Lee Cuno, Sayre, PA (US); James Scott Sutherland, Painted Post, NY (US); John Forrest Wight, Jr., Corning, NY (US)

(21) Appl. No.: 18/283,983

(22) PCT Filed: Mar. 30, 2022
(86) PCT No.: PCT/US2022/022499

§ 371 Date: Sep. 25, 2023

Related U.S. Application Data
(60) Provisional application No. 63/167,807, filed on Mar. 30, 2021.

(51) Int. Cl. B28B 7/34; B01D 39/20; B01J 19/24; B28B 3/02; C04B 38/00

(52) U.S. Cl. CPC B28B 7/342; B01D 39/2075; B01J 19/2485; B28B 3/025; C04B 38/0009; B01D 2239/10; B01J 2219/2403; B01J 2219/2438

(57) ABSTRACT

A process for forming a fluidic module (150) with integrated fluid separation includes positioning a first positive passage mold (115A) of a first fluid passage (170) having a tortuous shape within a volume of binder-coated ceramic powder (110A) and positioning a second positive passage mold (115B) of a second fluid passage (175) having a tortuous shape within the volume of ceramic powder (110A) and spaced apart from the first positive passage mold (115A). The process further includes positioning a powder interconnect (120) adjacent to a portion of each of the first (115A) and second positive passage molds (115B) within the volume of ceramic powder (110A), pressing the volume of ceramic powder (110A, HOB) with the first and second positive passage molds (115A, 115B) and the powder interconnect (120) inside to form a pressed body (148), heating the pressed body to remove the first and second positive passage molds (115A, 115B), and sintering the pressed body (148) to form a closed-porosity ceramic body (150).

### CROSS-REFERENCE TO RELATED APPLICATIONS

This patent application claims the benefit of priority under 35 U.S.C. § 119 of U.S. Provisional Application No. 63/167,807, filed on Mar. 30, 2021, the content of which is incorporated herein by reference in its entirety.

### FIELD OF THE DISCLOSURE

The disclosure relates to monolithic ceramic structures with integrated porosity and more particularly to methods of forming monolithic ceramic fluidic modules with porous and non-porous structures to provide integrated fluid separation and/or integrated temperature regulation and monolithic ceramic fluid modules formed from such methods.

### BACKGROUND

Silicon carbide ceramic (SiC) is a desirable material for fluidic modules for flow chemistry production and/or laboratory work and for structures for other technical uses. SiC has relatively high thermal conductivity, which is useful in performing and controlling endothermic or exothermic reactions. SiC has good physical durability and thermal shock resistance. SiC also possesses extremely good chemical resistance. But these properties, combined with high hardness and abrasiveness, make the practical production of SiC structures with internal features, such as SiC flow modules with tortuous internal passages, challenging.

Flow reactors and other structures formed of SiC and other ceramics have been fabricated recently by this Applicant using a variation of the “lost-material” approach. In this approach, a positive passage mold is incorporated within a volume of binder-coated ceramic powder. The ceramic powder with the passage mold inside is then pressed to form a green ceramic body, which thereafter undergoes further processing, such a demolding, debinding, and sintering, to form a sintered ceramic body with one or more smooth-surfaced fluidic passages extending therethrough.

### SUMMARY

An example process for forming a fluidic module with integrated fluid separation includes positioning a first positive passage mold of a first fluid passage having a tortuous shape within a volume of binder-coated ceramic powder, positioning a second positive passage mold of a second fluid passage having a tortuous shape within the volume of ceramic powder and spaced apart from the first positive passage mold, positioning a powder interconnect adjacent to a portion of each of the first and second positive passage molds within the volume of ceramic powder, pressing the volume of ceramic powder with the first and second positive passage molds and the powder interconnect inside to form a pressed body, heating the pressed body to remove the first and second positive passage molds, and sintering the pressed body to form a closed-porosity ceramic body. The closed-porosity ceramic body includes respective first and second tortuous fluid passages extending therethrough and an open-porosity ceramic region fluidically connecting the first and second tortuous fluid passages, the open-porosity ceramic region corresponding to the powder interconnect.

An example process for forming a fluidic module with integrated temperature regulation includes positioning a first positive passage mold of a first fluid passage having a tortuous shape within a volume of binder-coated ceramic powder, positioning a second positive passage mold of a second fluid passage having a tortuous shape within the volume of ceramic powder and spaced apart from the first positive passage mold, a length of the second positive passage mold highly filled with ceramic particles, pressing the volume of ceramic powder with the first and second positive passage molds inside to form a pressed body, heating the pressed body to remove the first and second positive passage molds and leave a self-supporting matrix of the ceramic particles, and sintering the pressed body to form a closed-porosity ceramic body having respective first and second tortuous fluid passages extending therethrough, the second tortuous fluid passage including an open-porosity ceramic region that occupies a volume of the second tortuous fluid passage along the length.

An example fluidic module for a flow reactor includes a monolithic closed porosity ceramic body, at least one tortuous fluid passage extending through the ceramic body, and at least one open-porosity ceramic region defining a portion of the at least one tortuous fluid passage.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 illustrates an example pressing die with a first layer of a non-porous ceramic powder layer.

FIG. 2 illustrates an example pressing die with channel forms disposed on the non-porous ceramic powder of FIG. 1.

FIG. 3 illustrates an example pressing die with porous ceramic powder disposed between the channel forms of FIG. 2.

FIG. 4 illustrates an example pressing die with a second layer of the non-porous ceramic powder layer over the channel forms and porous ceramic powder of FIG. 3.

FIG. 5 illustrates an example pressing die with a ram for applying a pressing force.

FIG. 6 illustrates an example pressing die with compressed non-porous ceramic powder, compressed porous ceramic powder, and compressed channel forms to form a pressed body.

FIG. 7 illustrates an example cross-sectional view of the pressed body of FIG. 6.

FIG. 8 illustrates an example cross-sectional view of a fluidic module with fluid passages, such as a retentate channel and a permeate channel, formed from the pressed body of FIG. 7 after a firing process.

FIG. 9 illustrates an example cross-sectional view of the fluidic module of FIG. 8 illustrating how certain process fluids and solids remain in the retentate channel.

FIG. 10 illustrates example unfilled channel forms with a mold filled with a porous ceramic powder disposed therebetween.

FIG. 11 illustrates an example pressing die with the channel forms of FIG. 10 disposed on a first layer of non-porous ceramic powder.

FIG. 12 illustrates a cross-sectional view of an example fluidic separation module.

FIG. 13 illustrates a cross-sectional view of an example fluidic separation module having serpentine bends.

FIG. 14 illustrates a cross-sectional view of an example fluidic separation module having an intermediate layer of porous material along a length of a fluidic channel.

FIG. 15 illustrates an example fluidic separation module employing multi-layer fluidic separation co-propagation or counter-propagation of flow in a serial configuration.

FIG. 16 illustrates an example fluidic separation module employing multi-layer fluidic separation co-propagation or counter-propagation of flow in a parallel configuration.

FIG. 17 illustrates an example of a fluidic separation module with multiple porous materials along the process/reactant fluid path to enable separation of multiple reaction product components.

FIG. 18 illustrates an example fluidic separation module with multiple porous materials arranged as a sieve.

FIG. 19 illustrates an exploded view of an example assembly of a two-piece fluidic separation module implementing a replaceable membrane positioned between an upper fluidic module component and a lower fluidic module component.

FIG. 20 illustrates an example assembled view of the example two-piece fluidic separation module of FIG. 19.

FIG. 21 illustrates an example fluidic module with example serpentine channel paths.

FIG. 22 illustrates an example configuration of a multi-layer fluidic module with an integrated heat exchanger having an open-porosity ceramic region that occupies a portion thereof.

FIG. 23 illustrates an example fluidic module with example external heat exchange structures to facilitate external heating.

FIG. 24 illustrates an example fluid module with porous heat exchange channels positioned adjacent to process/reactant channels.

FIG. 25 illustrates an example cross-sectional view of an example U-shaped air bearing.

FIG. 26 illustrates an example cross-sectional view of an example U-shaped air bearing having porous and non-porous regions.

FIG. 27 illustrates an example cross-sectional view of an example U-shaped air bearing with porous and non-porous regions and an air inlet.

FIG. 28 illustrates an example cross-sectional view of the example U-shaped air bearing of FIG. 27 supporting a molten ribbon.

FIG. 29 illustrates an example cross-sectional view of the example U-shaped air bearings of FIGS. 27-28 supporting a molten sheet.

FIG. 30 illustrates an example cross-sectional view of another example U-shaped air bearing having vacuum regions.

FIG. 31 illustrates an example cross-sectional view of the example U-shaped air bearing of FIG. 30 supporting a molten ribbon.

FIG. 32 illustrates an example cross-sectional view of the example U-shaped air bearings of FIGS. 30-31 supporting a molten sheet.

FIG. 33 illustrates an example cross-sectional view of an example porous mold for vacuum forming heated glass sheets into complex shapes.

FIG. 34 illustrates an example cross-sectional view of the example porous mold of FIG. 33 with a glass sheet disposed thereon.

FIG. 35 illustrates an example cross-sectional view of an example glass sheet being ejected from the example porous mold of FIG. 34.

FIG. 36 illustrates an example cross-sectional view of an example wafer carrier having a porous top surface.

FIG. 37 illustrates an example cross-sectional view of the example wafer carrier of FIG. 36 ejecting an example wafer.

FIG. 38 illustrates an example cross-sectional view of an example rotating bearing.

### DETAILED DESCRIPTION

Techniques for forming porous and non-porous regions in pressed ceramic fluidic modules, where porous regions are created using ceramic powders with different properties and/or encapsulation of these powders in channel forms. The approach is useful for forming complex structures inside pressed ceramic fluidic modules, for use in solid/liquid and solid/gas phase separations, and filtration applications. The approach can also be applied to other bodies that include porous and non-porous surfaces or channels to implement a specific function, such as a high temperature air bearing surface for supporting molten glass sheets during processing, and many other applications provided in this disclosure. The approach can also be applied to ceramic bodies that include porous and non-porous surfaces or channels to implement a specific function. For example, the approach may be applied to air bearings, porous molds, wafer carriers, lubricated bearings, optimized mechanical structures, porous burners, fuel cells, metal filtration, and disc brakes, to name a few.

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or endpoint referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with a path of the passage having at least two differing radii of curvature, the path of the passage being defined mathematically and geometrically as a curve formed by successive geometric centers, along the passage, of successive minimum-area planar cross sections of the passage (that is, the angle of a given planar cross section is the angle which produces a minimum area of the planar cross section at the particular location along the passage) taken at arbitrarily closely spaced successive positions along the passage. Typical machining-based forming techniques are generally inadequate to form such a tortuous passage. Such passages may include a division or divisions of a passage into subpassages (with corresponding subpaths) and a recombination or recombinations of subpassages (and corresponding subpaths).

As used herein a “monolithic” ceramic structure does not imply zero inhomogeneities in the ceramic structure at all scales. A “monolithic” ceramic structure or a “monolithic” ceramic fluidic module, as the term “monolithic” is defined herein, refers to a ceramic structure or fluidic module, with one or more tortuous passages extending therethrough, in which no (other than the passage(s)) inhomogeneities, openings, or interconnected porosities are present in the ceramic structure having a length greater than the average perpendicular depth of the one or more passages from the external surface of the structure or module. For ceramic structures or ceramic fluidic modules with other geometries, such as non-planar or circular geometries, the term “monolithic” refers to a ceramic structure or fluidic module, with one or more tortuous passages extending therethrough, in which no (other than the passage(s)) inhomogeneities, openings, or interconnected porosities are present in the ceramic structure having a length greater than (i) the minimum depth of the one or more passages P from the external surface of the structure or module and (ii) the minimum spacing between separate, spaced-apart portions of the one or more passages P from one another. Fluidic ports that are machined and/or molded in the structure or module so as to intentionally enable fluid communication from the outside of the structure or module to the passages and/or between separate, spaced-apart portions of the passages, such as inlet ports and/or outlet ports, are excluded from the determination of the average perpendicular depth, the minimum depth, and/or the minimum spacing. Providing such a monolithic ceramic structure or monolithic ceramic flow module helps ensure fluid tightness and good pressure resistance of a flow reactor fluidic module or similar product.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

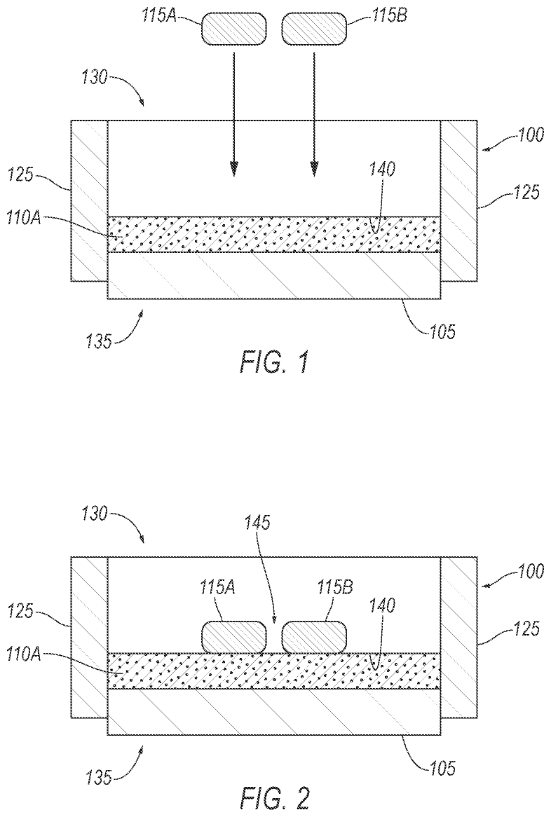

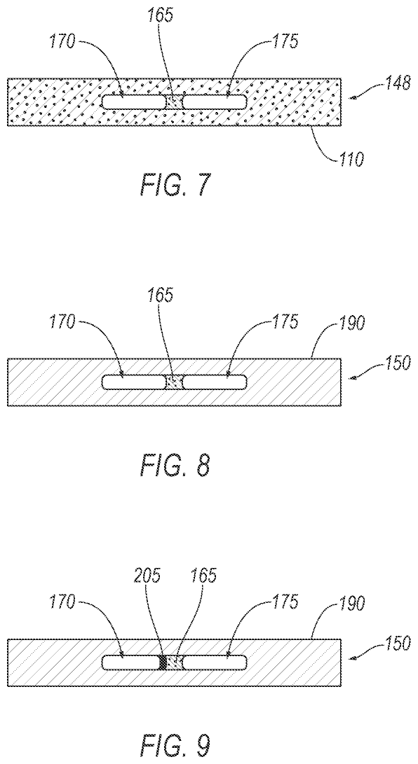

A first example technique for integrating porous regions into non-porous ceramic bodies that may also include internal channels or fluid passages is disclosed with respect to FIGS. 1-9, which show a die 100, a plug 105, a non-porous ceramic powder 110, channel forms 115, and a porous ceramic powder 120. With general reference to FIGS. 1-9, the die 100 is formed of at least one rigid sidewall 125 with an interior shape that at least partially matches an outer configuration of a ceramic body of a pressed fluidic module. The die 100, also referred to as a pressing die 100, includes a first opening 130 and a second opening 135 defined by the at least one rigid sidewall 125 and spaced from one another. For instance, the first opening 130 may be located at a top of the die 100 and the second opening 135 may be located at a bottom of the die 100. The plug 105 is insertable into the second opening 135 of the die 100. The plug 105 may be inserted into the second opening 135 of the die 100 to allow materials, such as the non-porous ceramic powder 110, the porous ceramic powder 120, and the channel forms 115 to be disposed inside the die 100 prior to pressing the materials into the ceramic fluidic module. The non-porous ceramic powder 110 in embodiments includes non-porous silicon carbide (SiC) ground or otherwise formed into a fine powder. In some possible approaches, the non-porous ceramic powder 110 is a ready-to-press (RTP) SiC powder that includes binder(s) and/or other additives mixed with or coated thereon to facilitate pressing. Examples of such RTP SiC powder include SICS-18 from GNPGraystar of Buffalo, NY, United States; IKH 601 and 604 from Industriekeramik Hochrhein (IKH) GmbH of Wutoschingen, Germany; and StarCeram S alpha-SiC types SQ and RQ from KYOCERA Fineceramics Precision GmbH of Selb, Germany. The channel forms 115, also called positive passage molds, comprise mold material that will melt when subjected to heat, e.g., during a sintering process. The melted mold material can thereafter be removed, leaving openings or voids that correspond to one or more fluid passages within the ceramic body. Two channel forms 115 are shown. A first channel form 115A may be used to form a first fluid passage, such as a retentate channel 170 as shown in FIGS. 7-9, and a second channel form 115B may be used to form a second fluid passage, such as a permeate channel 175 as shown in FIGS. 7-9. The porous ceramic powder 120 in embodiments includes porous silicon carbide (SiC) ground or otherwise formed into a fine powder and having a porosity ranging from 9% to 95%. In some instances, the porous ceramic powder 120 acts as a powder interconnect between various channels of the fluidic module, which are discussed in greater detail below. In a traditional ceramic fluidic module fabrication process, the die 100 would be filled such that the non-porous ceramic powder 110 would surround the channel forms 115. Then, through subsequent processing steps such as demolding, debinding, and firing, the non-porous ceramic powder 110 is transformed into a dense ceramic material (e.g., over 97% density) with closed porosity. As used herein a “closed-porosity” ceramic body is a ceramic body in which the ceramic material of the ceramic body exhibits a pore topology that is closed such that the pores or cells in the material are isolated or connected only with adjacent pores or cells and have no permeability to fluid.

A process for making a fluidic module 150 with non-porous regions is disclosed with respect to FIGS. 1-9. To make a fluidic module 150 with non-porous regions, a different type of RTP ceramic powder, referred to as porous ceramic powder 120, can be inserted into selected regions of the pressing die 100. This powder is designed to not achieve closed porosity after the same demolding, debinding, and firing processing described above for achieving dense ceramic material. The porous ceramic powder 120 can be formulated various ways to introduce voids around the ceramic primary particles or agglomerated granules, resulting in local porosity. Examples may include spray drying with a high level of organic binder (e.g., >4-8 wt %), adding pore formers that burn out prior to firing (e.g., starch, graphite, methocel), modifying the particle size distribution (PSD) of the ceramic powder such as by reducing or eliminating smaller ceramic particles or agglomerated granules that would otherwise fill interstitial gaps between larger particles or granules, or adding larger ceramic primary particles—potentially in a mixture with RTP ceramic powders—that will not fully sinter together in firing to create voids. Using these techniques, the open porosity of the ceramic powder can be engineered to enable the variety of applications described in greater detail below. One aspect to the approach is having a technique for providing different ceramic powders (e.g., porous and non-porous) at different locations within the fluidic module 150.

As illustrated in FIGS. 1 and 2, the non-porous ceramic powder 110 is inserted into the die 100 through the first opening 130. The non-porous ceramic powder 110 forms a first layer 110A on the plug 105. The channel forms 115 are inserted into the die 100 through the first opening 130 onto a top surface 140 of the non-porous ceramic powder 110.

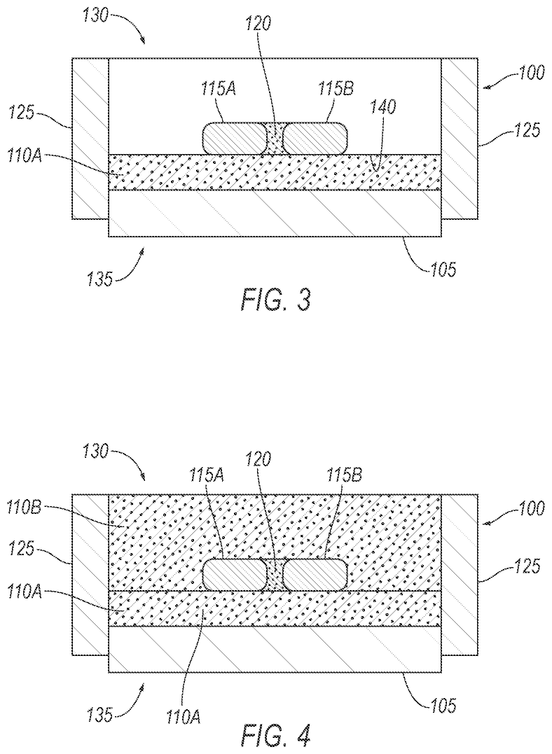

Referring now to FIGS. 2-3, the porous ceramic powder 120 is poured through the first opening 130 and into a gap region 145 between the first channel form 115A and the second channel form 115B. Doing so allows the porous ceramic powder 120 to remain in contact with the channel forms 115 after fabrication, thereby enabling flow of liquid through the porous ceramic regions. In implementations, porous domains within the fluidic module 150 can be controlled by inserting a wall structure comprising, for example, one or more walls during the powder filling process. The wall structure may take the form of a thin piece of metal, paper, or sheet of wax inserted in a predetermined region, for example, about the gap region 145. After filling the die 100 with the porous ceramic powder 120 and non-porous ceramic powder 110, the wall structure can be removed while preventing significant displacement and inter-mixing of the porous ceramic powder 120 and non-porous ceramic powder 110. Alternatively, in the case of a paper or wax, the wall structure can be left in place so that it burns out or melts in subsequent high temperature processing steps. Other techniques for forming porous regions will be described in the next section.

Referring now to FIG. 4, once the porous ceramic powder 120 is positioned between the channel forms 115, a second layer 110B of non-porous ceramic powder 110 is introduced into the first opening 130 of the die 100. The second layer 110B of non-porous ceramic powder 110 covers the channel forms 115, the porous ceramic powder 120, and any exposed parts of the top surface 140 of the first layer 110A of the non-porous ceramic powder 110. In embodiments, the second layer 110B of non-porous ceramic powder 110 is thicker than the first layer 110A of non-porous ceramic powder 110 introduced into the die 100 in FIG. 1.

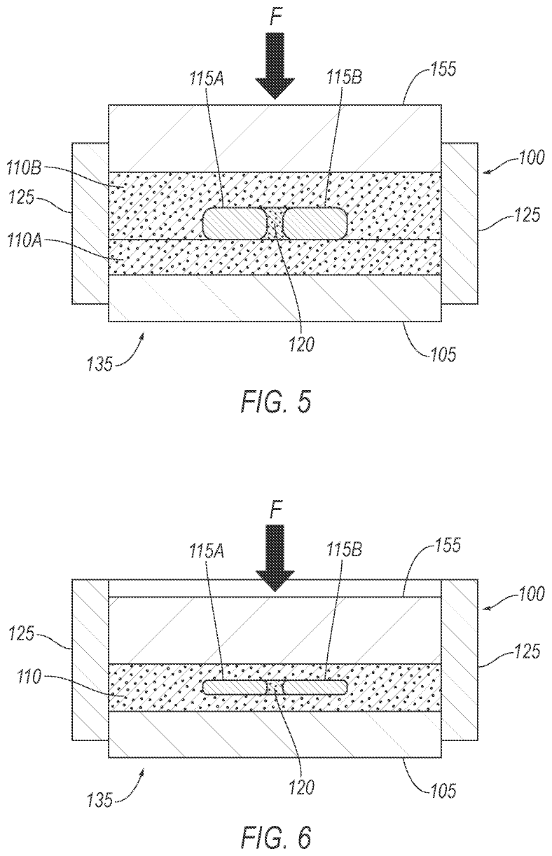

With reference now to FIGS. 5-8, a green pressed body 148 corresponding to the fluidic module 150 is formed by inserting a ram 155 into the die 100 through the first opening 130 and compressing, with a pressing force F, the first layer 110A and the second layer 110B of the non-porous ceramic powder 110 along with the porous ceramic powder 120 and channel forms 115. The ram 155 is inserted into the first opening 130 of the die 100 in a vertical direction along the direction of gravity. The compression may cause the channel forms 115 to broaden in a horizontal direction while a thickness of the channel forms 115, first layer 110A and second layer 110B of the non-porous ceramic powder 110, and the porous ceramic powder 120 is reduced.

Referring now to FIG. 7, the pressed body 148 is removed from the die 100 and heated to remove the channel forms 115. The channel forms 115 may be removed through a mold removal process including, but not limited to, press plate demolding, air bladder demolding, or isostatic demolding. The mold removal process may further or alternatively include an air blowout process. With the channel forms 115 removed, the fluidic module 150 defines a retentate channel 170 and a permeate channel 175. The pressed body 148 is then de-bound to remove the powder binder, and then fired (sintered) to densify and further solidify the pressed body into a monolithic ceramic body corresponding to the fluidic module 150. Example process parameters for pressing the ceramic powder to form the pressed body 148 and for demolding, debinding, and firing the pressed body 148 to form the fluidic module 150 are described in International Application Publication No. WO 2021/067455 A1, filed on Sep. 30, 2020, the disclosure of which is incorporated by reference in its entirety.

The ceramic body or ceramic body portion of the fluidic module 150 can be formed from a ceramic material that includes any pressable powder that is held together by a binder and thermally processed to fuse the powder particles together into a structure. The ceramic material in some embodiments includes oxide ceramics, non-oxide ceramics, glass-ceramics, glass powders, metal powders, and other ceramics that enable high density, closed-porosity monolithic structures. Oxide ceramics are inorganic compounds of metallic (e.g., Al, Zr, Ti, Mg) or metalloid (Si) elements with oxygen. Oxides can be combined with nitrogen or carbon to form more complex oxynitride or oxycarbide ceramics. Non-oxide ceramics are inorganic, non-metallic materials and include carbides, nitrides, borides, silicides and others. Some examples of non-oxide ceramics that can be used for the ceramic body 200 include boron carbide (B₄C), boron nitride (BN), tungsten carbide (WC), titanium diboride (TiB₂), zirconium diboride (ZrB₂), molybdenum disilicide (MoSi₂), silicon carbide (SiC), silicon nitride (Si₃N₄), and sialons (silicon aluminum oxynitrides). The ceramic body in the exemplary embodiment is formed from SiC.

The mold material of the channel forms or positive passage molds can be an organic material such as an organic thermoplastic. The mold material can include organic or inorganic particles suspended or otherwise distributed within the material as one way of decreasing expansion during heating/melting. The material of the passage mold is desirably a relatively incompressible material—specifically a material with low rebound after compression relative to the rebound of the pressed ceramic powder after compression. Mold materials loaded with particles can exhibit lower rebound after compression. Mold materials which are capable of some degree of non-elastic deformation under compression also naturally tend to have low rebound (e.g., materials with high loss modulus). Polymer substances with little or no cross-linking, for example, and/or materials with some local hardness or brittleness which enables localized fracturing or micro-fracturing upon compression can exhibit low rebound. Useful mold materials can include waxes with suspended particles such as carbon and/or inorganic particles, rosin containing waxes, high modulus brittle thermoplastics, and even organic solids suspended in organic fats such as cocoa powder in cocoa butter—or combinations of these. Low melting point metal alloys also may be useful as mold materials, particularly alloys having low or no expansion on melting.

As shown in FIG. 8, after subjecting the fluidic module 150 to a firing process, the retentate channel 170 and permeate channel 175 are linked by a porous region 165 filled with porous ceramic material formed from the compression and heating of the porous ceramic powder 120 and a non-porous region filled with non-porous ceramic material 190 formed from the compression and heating of the non-porous ceramic powder 110. The non-porous region at least partially surrounds the retentate channel 170, the permeate channel 175, and the porous region 165. As such, the porous region 165 defines an open-porosity ceramic region and the non-porous region defines a closed-porosity ceramic body that encompasses the open-porosity ceramic region. In some instances, discussed in greater detail below, the fluidic module 150 may define inlet ports, outlet ports, and other channel structures such as mixtures and residence time sections integrated into the fluid separator structure.

In operation the retentate channel 170 may be supplied with a process fluid, and the retentate channel 170 may be defined such that a portion of the process fluid flows through the porous region 165 with the porous ceramic material and into the permeate channel 175, as shown in FIG. 9. Process fluids and solids 205 that cannot pass through the porous region 165 remain in the retentate channel 170 for subsequent removal.

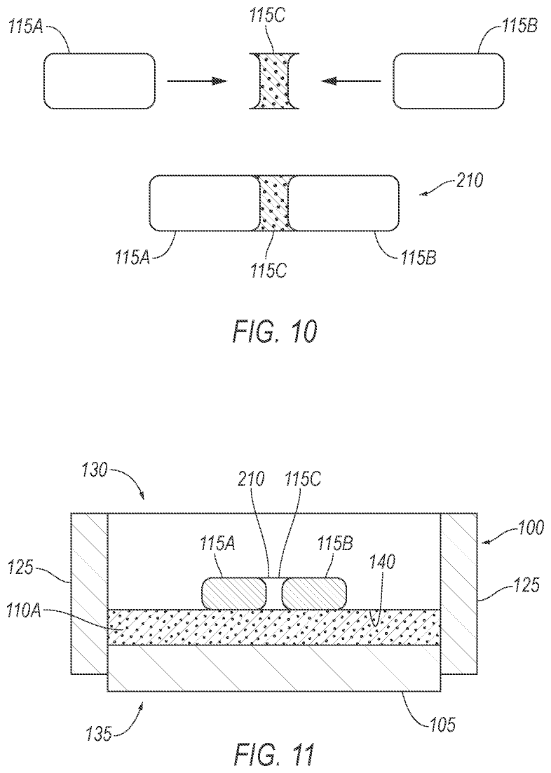

With reference now to FIG. 10, another approach for creating porous regions 165 in the fluidic module 150 involves fabricating a solid body 210, such as a single channel form 115, that contains or encapsulates ceramic materials that will be porous after firing. For example, ceramic primary particles can be mixed with heated mold material and cast into various shapes to form a third channel form 115C. The third channel form 115C, sometimes referred to as an interconnect mold, is highly filled with ceramic materials or particles such that a self-supporting matrix of the ceramic material or ceramic particles remains after removal of a mold material portion of the third channel form 115C, for example, after demolding and firing/sintering as described above.

After sintering, the self-supporting matrix defines an open-porosity ceramic region configured to provide at least some open porosity to enable fluid transport therethrough. As an example, when the porous self-supporting matrix forms a wall or a portion of a wall of a fluid passage, the open porosity can be less than 1%, less than 2%, or less than 5% of the volume of the wall after sintering. In embodiments, the open porosity can be larger, for example, less than 10%, less than 15%, less than 20%, or less than 25% of the volume of the wall after sintering. Considering the theoretical density of the materials of the fluidic module 150, if, for example, a minimum theoretical density of at least 97% is needed to ensure that the wall has no open porosity, the portion of the wall formed by the porous self-supporting matrix can have a theoretical density that is 1%, 2%, or 5% less than the minimum theoretical density to provide some open porosity while remaining mechanically rigid. The open porosity can provide fluid paths through the open-porosity ceramic region where the mean hydraulic diameter of the flow path as determined by interconnected open void cavities or interstitial regions formed between joined ceramic particles is less than 50 nm, or less than 100 nm, or less than 500 nm, or less than 1 um, or less than 2 um, or less than 5 um. As used herein, a “self-supporting matrix” or “porous self-supporting matrix” means that the matrix of ceramic material or ceramic particles maintains its shape and position relative to the close-porosity ceramic body from initial placement through all processing steps to the final sintered channel structure geometry.

In embodiments, the third channel form 115C can be joined with unfilled channel forms 115, such as the first channel form 115A and second channel form 115B, shown in FIG. 10. Bonding can take place by shaping the first channel form 115A, the second channel form 115B, and the third channel form 115C so that two or more of the first channel form 115A, the second channel form 115B, and the third channel form 115C fit or lock together. In embodiments, the two or more of the first channel form 115A, the second channel form 115B, and the third channel form 115C can be bonded together via local heating of their respective surfaces prior to joining two or more of the first channel form 115A, the second channel form 115B, and the third channel form 115C, or by applying molten mold material on their respective surfaces prior to joining two or more of the first channel form 115A, the second channel form 115B, and the third channel form 115C.

With continued reference to FIGS. 10-11, the single channel form 115 has a first region, a second region, and a third region that may be used to define the retentate channel 170, the permeate channel 175, and the porous region 165, respectively. The single channel form 115 may be inserted into the die 100 through the first opening 130 and placed on the top surface 140 of the first layer 110A of non-porous ceramic powder 110. The first region of the single channel form 115 and the second region of the single channel form 115 may be formed from unfilled mold material, which is the mold material used to create the first channel form 115A and the second channel form 115B discussed above with reference to FIGS. 1-9. The third region of the single channel form 115 may be formed from a filled channel form 115 material, such as the material used to form the third channel form 115C discussed above with respect to FIG. 10.

As shown in FIGS. 10-11, the third region of the single channel form 115 is located between the first region and the second region of the single channel form 115. The single channel form 115 may be created by bonding multiple channel forms 115, as discussed above. After the mold material cools, the single channel form 115 may be removed from the mold so that it may be inserted into the die 100 for inclusion into the fluidic module 150, as shown in FIG. 11. This approach increases the likelihood that porous and non-porous regions of the fluidic module 150 are positioned at the desired locations relative to each other. It further enables precise definition of the porous and non-porous regions, including graded profiles between porous and non-porous materials, and thin layers of porous materials in specific locations.

In embodiments, rather than form the single channel form 115, the porous ceramic powder 120 can be encased or encapsulated in a coating material such as wax or a polymer to create a body that can be more easily moved, manipulated, and positioned. Solid bodies containing porous ceramic materials can also be formed in sheets and stencil cut to the desired channel form shapes. The sheets can be formed in a variety of ways including cast from filled mold material as previously discussed, dry pressed by mixing raw porous ceramic powder 120 materials with other binder materials, dry pressed by mixing RTP ceramic powders with pore formers such as starches, graphite, or polymers, or mixed with a solvent and binders before being rolled or tape-cast into a sheet. In these and other alternative approaches, porous region 165 layers can be formed by placing formed sheets on a bed of non-porous ceramic powder 110 prior to pressing.

In embodiments, ceramic materials suitable for forming porous ceramic regions in fluidic modules 150 after firing can also be mixed with liquids, binders, and pore formers as described above to form highly filled pastes and slurries. The pastes and slurries can be injected or applied at specific locations, such as on the surface of an unfilled channel form 115, or in gap regions 145 between channel forms 115, either before or after the channel form 115 is inserted into the pressing die 100. Pastes and slurries can also be applied directly to non-porous ceramic powders 110 that have been previously inserted into the pressing die 100, creating porous regions 165 bounded by surrounding non-porous materials.

The porous regions 165 formed within pressed ceramic fluidic module 150 can also be employed as a support for membrane coatings. Membrane coatings can be washcoated onto porous regions 165 to provide precision size voids. The porosity of the porous ceramic can be engineered to promote low pressure drop flow of fluids through the washcoated region. Catalytic coatings can also be applied over porous regions 165 to promote chemical reactions that would not be possible otherwise.

The foregoing process of manufacturing ceramic fluidic modules 150 can be used in various applications including chemical reactor applications, air bearings, porous molds, wafer carriers, lubricated bearings, optimized mechanical structures, porous burners, fuel cells, metal filtration, disc brakes, and others.

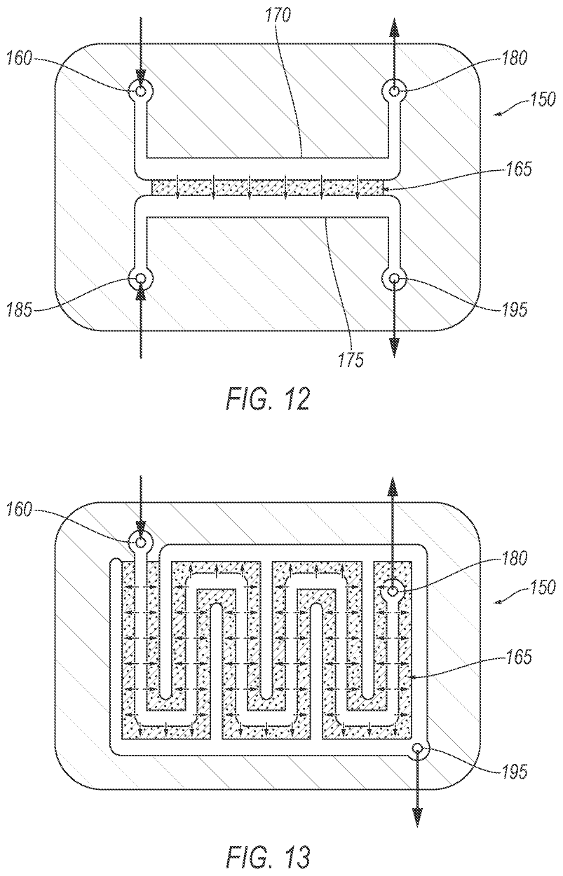

With respect to chemical reactor applications, fluidic separation can help remove wanted or unwanted reaction products and increase reaction selectivity. Examples of separation in continuous flow chemistry include liquid/liquid, solid/liquid, gas/liquid, and solid/liquid/gas. An example fluidic separation module 150 is shown in the plan cross-sectional view of FIG. 12. As shown, process fluid enters through a process fluid inlet port 160 and flows through the retentate channel 170 past a porous material region 165. A portion of the process fluid passes through the porous material region 165 within the fluidic module 150 and into the permeate channel 175. Process fluids that do not pass through the porous material (e.g., solids or immiscible liquids 205 as shown in FIG. 9) exit the fluidic module 150 through a retentate fluid outlet port 180. With continued reference to FIG. 12, a sweep fluid, which enters via a sweep fluid inlet port 185, can help remove separated permeate from the permeate channel 175 near the porous material, which can exit the fluidic module 150 via a permeate fluid outlet port 195. Fluidic separation may be enhanced by applying membrane washcoats to porous material regions 165. Depending on the needs of the fluidic separation operation, other functions, such as mixers and residence time sections, can be added to the same fluidic module 150. Multiple fluidic separation operations can be performed to successive refine reaction products to increase selectivity. These fluidic separation operations can be carried out under different conditions, such as different local temperatures, pressures, or chemical compositions.

Fluidic separation can occur along a length of the fluidic channel, as shown in FIG. 12. Porous regions 165 can be provided along one or both sides of the process fluid channel, enabling continuous separation of chemical products into an adjacent permeate fluid channel. The permeate channel 175 can run parallel to the process fluid/retentate channel 170, or it can be interdigitated with process fluid serpentine bends as shown in FIG. 13.

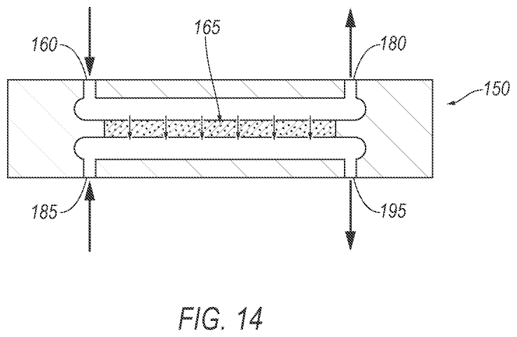

In the examples above, the process/retentate channels 170, permeate channels 175, and porous material regions 165 are all located in the same plane. The pressed ceramic fluidic module 150 fabrication process may alternatively be applied in multiple layers. In that example approach, process/retentate and sweep/permeate fluidic channels can be positioned over one another, with an intermediate layer of porous material separating them, as shown in FIG. 14. This approach can be used to increase the surface area of interchange between the process/retentate channel 170 and the sweep/permeate channel 175. Hybrid solutions are also possible, where porous materials are located on multiple sides of the process/retentate channel 170. For example, the porous materials may be located in the same plane as the process/retentate channel 170 as shown in FIG. 13, as well as in a different layer as shown in FIG. 14.

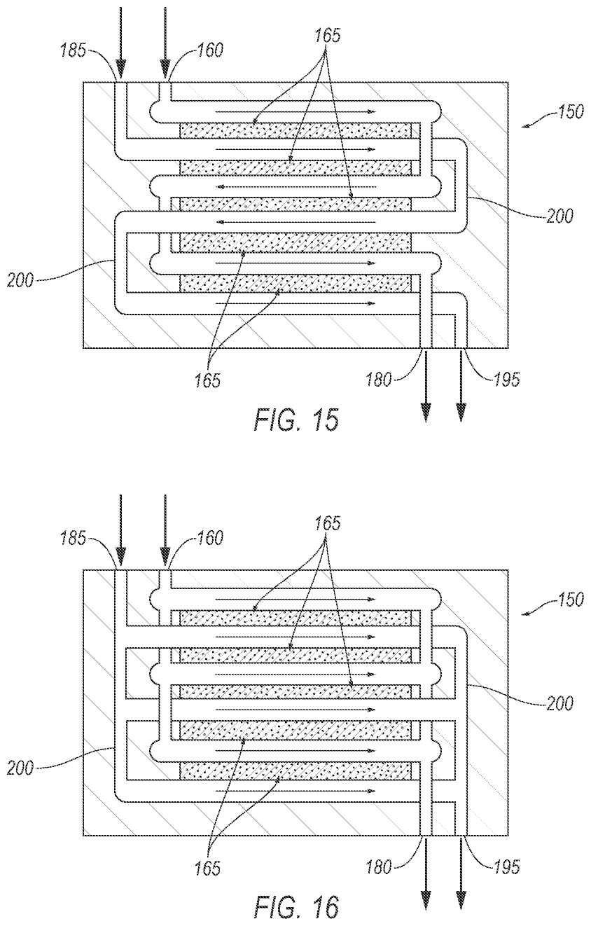

FIG. 15 illustrates multi-layer fluidic separation employing co-propagation or counter-propagation of flow in a serial configuration. In this example approach, fluidic separation can be scaled up within a fluidic module 150 using a multi-layer configuration. As shown, the process/retentate fluid flow is in the same direction as an adjacent sweep/permeate fluid (“co-propagation”), but counter-propagation can be implemented in the same fluidic module 150. The fluidic separation module 150 of FIG. 15 includes the sweep fluid inlet port 185, the process fluid inlet port 160, the retentate fluid outlet port 180, the permeate fluid outlet port 195, and internal vias 200 connecting the various fluid flow channels. A layer of porous material 165 is adjacent to each of the various fluid flow channels.

FIG. 16 illustrates multi-layer fluidic separation employing co-propagation or counter-propagation of flow in a parallel configuration. As shown in FIG. 16, multi-layer fluidic separation can be implemented in a parallel configuration to reduce pressure drop through the fluidic module 150. Depending on the configuration of flow in the channels, multi-layer fluidic separation can be implemented using co-propagation or counter-propagation flow. Cross-flow configurations are also possible by, e.g., changing the way internal vias 200 intercept the channel layers. The fluidic separation module 150 of FIG. 16 includes the sweep fluid inlet port 185, the process fluid inlet port 160, the retentate fluid outlet port 180, the permeate fluid outlet port 195, and internal vias 200 connecting the various fluid flow channels. A layer of porous material is adjacent to each of the various fluid flow channels.

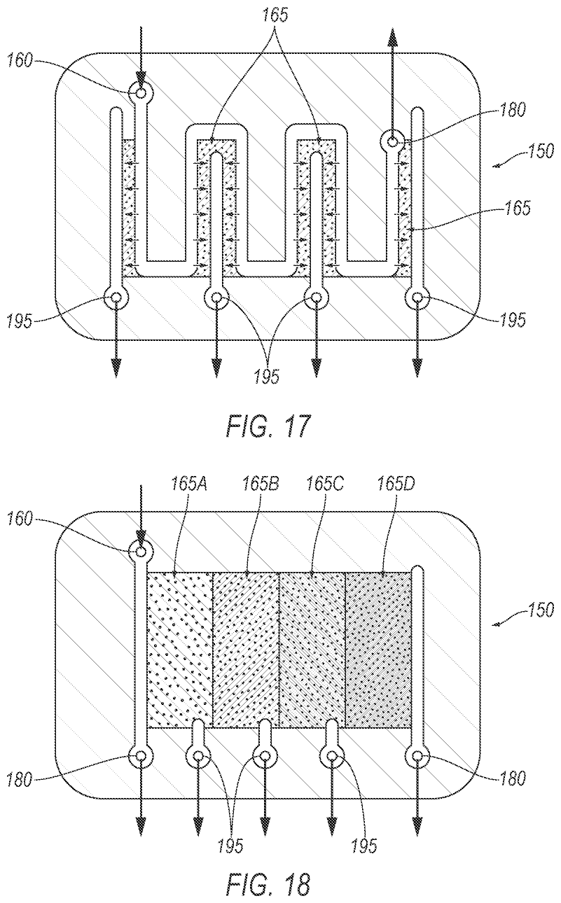

FIG. 17 is an example of a fluidic separation module 150 with four different porous materials along the process/reactant fluid path to enable separation of multiple reaction product components. The fluidic separation module 150 of FIG. 17 includes the process fluid inlet port 160, the retentate fluid outlet port 180, and multiple permeate fluid outlet ports 195. A layer of porous material is disposed between certain fluid flow channels or portions thereof. The fabrication process disclosed herein enables incorporation of multiple porous materials at different locations within the fluidic module 150. For example, four different porous materials with different pore sizes can be arranged along a serpentine reaction path as shown in FIG. 17. This approach can be used to separate out particulates of various sizes along the path.

In another possible implementation, FIG. 18 shows a fluidic separation module 150 with multiple porous materials arranged as a sieve. In this example approach, layers of porous materials 175A-175D can be arranged serially in zones so that the flow path acts like a stack of sieves to remove different reaction product components. As illustrated in FIG. 18, the fluidic separation module 150 includes the process fluid inlet port 160, the retentate fluid outlet port 180, multiple permeate fluid outlet ports 195, and multiple regions of different porosity. As shown, each fluid outlet port is adjacent to a different porous material 175A-175D. While the example configuration in FIG. 18 shows different porous materials arranged in the same plane, a similar approach can be implemented where different porous materials are arranged in different layers or planes and reactant fluid flow is directed downward through the various layers. As such, each layer provides a dedicated permeate fluid outlet.

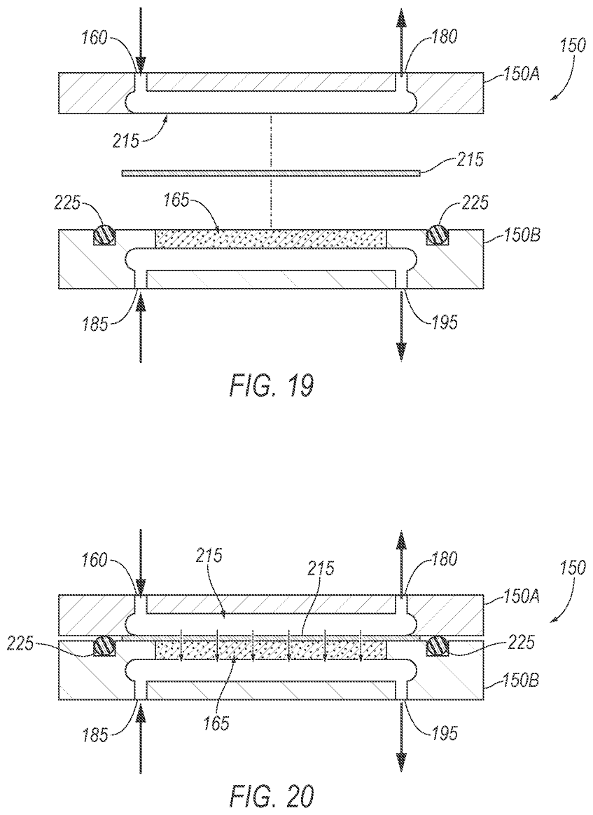

FIGS. 19-20 illustrate an assembly of a two-piece fluidic separation module 150 implementing a replaceable membrane 215 positioned between an upper fluidic module component 150A and a lower fluidic module component 150B. In some cases, it may be difficult to washcoat porous regions 165 uniformly or with sufficient material to achieve desired separation functions. Additionally, some reactant fluids can promote degradation of membrane washcoats, through, for example, clogging, loss of chemical activity, or poisoning. The removeable membrane or another type of filtration substrate can be periodically removed from the fluidic module 150 and replaced. The fluidic separation module 150 of FIGS. 19-20 includes a process fluid inlet port 160 and a retentate fluid outlet port 180 on the upper fluidic module component 150A. The upper fluidic module component 150A may further define a cavity 220 between the process fluid inlet port 160 and the retentate fluid outlet port 180. The fluidic module 150 of FIGS. 19-20 further includes the sweep fluid inlet port 185, the permeate fluid outlet port 195, and the porous region 165 on the lower fluidic module component 150B. The replaceable membrane 215 is positioned between the upper fluidic module component 150A and the lower fluidic module component 150B. The membrane 215 is aligned to a porous material region 165 on the lower fluidic module component 150B. At least one of the upper fluidic module component 150A and the lower fluidic module component 150B may further define O-ring glands configured to accept an O-ring 225.

Referring now to FIG. 20, the two-piece fluidic module 150 may be assembled and held together using external clamps. When assembled, the cavity 220 is adjacent the membrane 215. In operation, the process fluid flows across the cavity 220, and a portion of the process fluid passes through the membrane 215 and the porous support material into a permeate fluid channel directly below the membrane 215. The porous support material supports the membrane 215, enabling the process/retentate channel 170 to be highly pressurized to intensify fluidic separation. To increase the pressure resistance of the porous support material, the sweep/permeate fluid channels can be implemented as a set of parallel channels, where intermediate regions of non-porous material serve as walls or posts to buttress the channel roof against collapse. Further with respect to chemical reactor applications, it will be appreciated that one or more porous regions 165 disposed between separate fluid passages can be used to provide progressive gas delivery from a first fluid passage (i.e., a gas delivery passage) to a second fluid passage (i.e., a reaction channel) along a portion of or an entire length of the reaction channel.

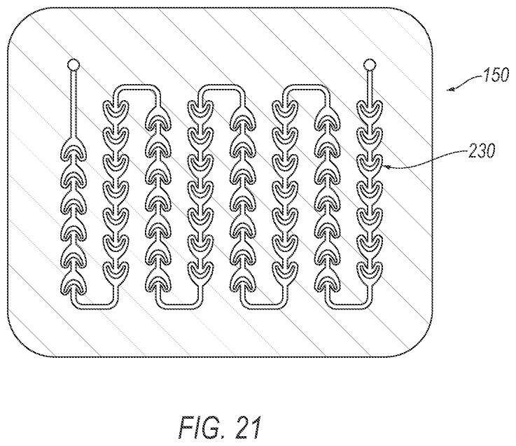

With reference now to FIG. 21, continuous flow chemistry often includes long residence time reactions that include relatively long reaction channel paths through the fluidic module 150. To keep the overall size of the fluidic module 150 to a manageable size, fluid channels may be routed in serpentine paths. In the example of FIG. 21, mixers 230 in a fluidic module 150 are arranged in columns. With this channel configuration, temperature changes in one column of mixers 230 (due to highly exothermic or endothermic reactions) can alter the temperature of channels and mixers 230 in adjacent columns. This is sometimes referred to as thermal crosstalk, and it can also occur in multilayer fluidic modules 150, where reactant channels on different layers are routed close to each other. One solution to thermal crosstalk for multilayer fluidic modules 150 involves positioning internal heat exchange channels on layers between reactant layers. One aspect of implementing internal heat exchange channels is pressure resistance, since they are positioned close to pressurized reactant channels in different layers. Heat exchange channels cannot be broad because of the risk of channel collapse. To increase pressure resistance, heat exchange channels can be formed using porous materials that enable fluid flow while providing good mechanical support. The porous materials can also enhance heat transfer into or out of the heat exchange channels by acting like fins to transfer heat between the center and sidewall surfaces of the heat exchange channel. While the porous channel are more likely to experience a higher pressure drop than a conventional heat exchange channel, pressure drops are generally less significant in heat exchange channels. Uniform flow in porous and non-porous channels can be achieved using flow control values or a pressure-regulated supply on the non-porous channels.

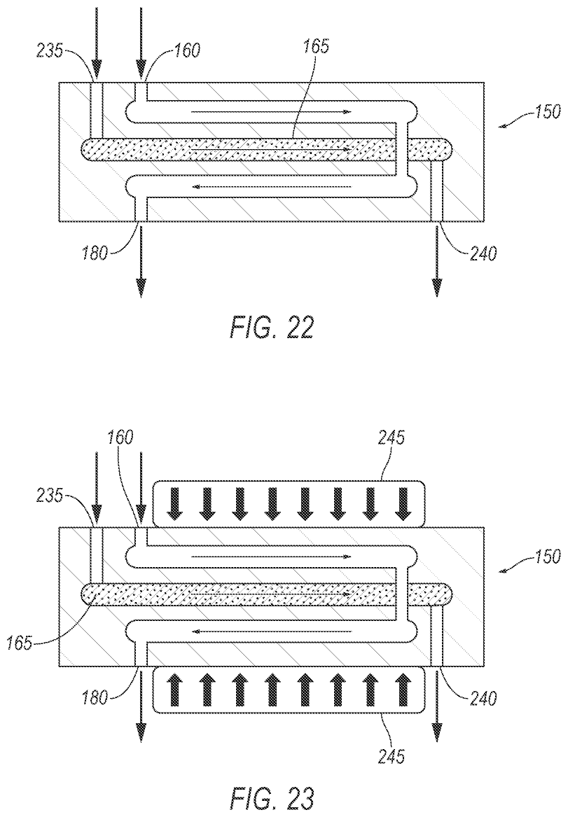

FIG. 22 illustrates an example configuration of a multi-layer fluidic module 150 with an integrated heat exchanger. In this example approach, a porous material layer is positioned between upper and lower process/reactant fluid layers. More specifically, the heat exchange channels of such an integrated heat exchanger can include an open-porosity ceramic region that occupies a volume of the heat exchange channels along a portion or an entirety of the length thereof. These heat exchange channels with an open-porosity ceramic region can be formed, for example, as described above using a positive passage mold highly filled with ceramic particles that is thereafter heated to remove the positive passage mold and leave a self-supporting matrix of the ceramic particles therein to be sintered during the fabrication process. One way for fluid to enter the porous material layer in FIG. 22 is via a heat exchange fluid inlet 235. Some fluid may exit the multi-layer fluidic module 150 via a heat exchange fluid outlet 240.

In another approach illustrated in FIG. 23, fluidic modules 150 can be implemented with external heat exchange structures 245 to facilitate external heating. Reactant channel multilayer thermal crosstalk can be controlled in this configuration via integration of heat exchange channel layers implemented with porous materials. In this case, the internal heat exchange channel can serve as a thermal isolation barrier between the upper and lower sections of the fluidic module 150. To achieve thermal isolation, the heat exchange channel working fluid can be flowing water, flowing air, or even static air that acts as an insulator.

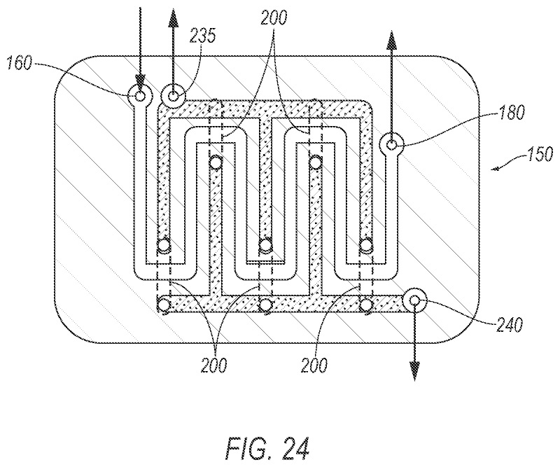

Porous material can also be placed in the horizontal plane to thermally isolate specific sections along the reaction path. FIG. 24 provides an example where porous heat exchange channels are positioned adjacent to process/reactant channels. Other configurations may include porous channels around specific regions along the reaction path where precise temperature control or thermal isolation are important. The porous heat exchange regions may be positioned on all sides of the process/reactant fluid channel (i.e., top, bottom, left, and right) separated from the process/reactant fluid channel by a non-porous wall.

The foregoing concepts may be implemented in various applications including air bearings, porous molds, wafer carriers, lubricated bearings, mechanical structures, porous burners, fuel cells, metal filtration, and disc brakes, among others.

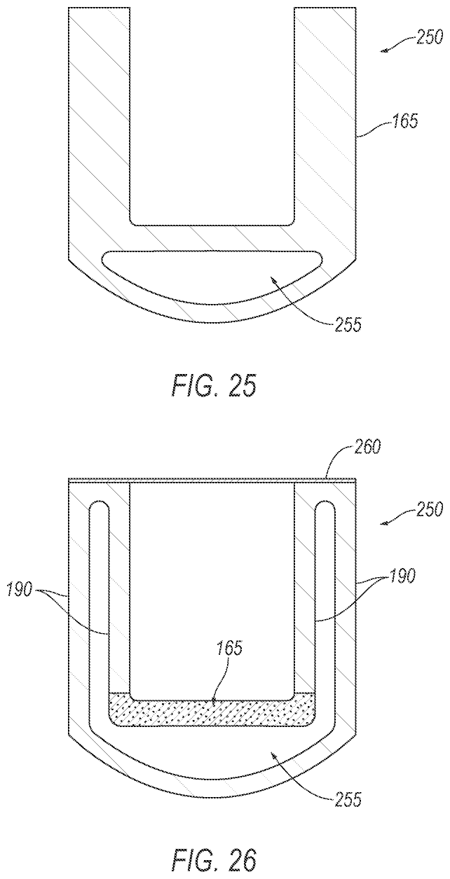

With reference now to FIGS. 25-32, air bearings 250 are used to support movable materials on a thin layer of air. They are sometimes used in situations where the movable materials could be damaged if they contact mechanical supports. An example is transportation of large glass sheets along an assembly line. Air bearings 250 are also useful in high temperature applications involving sheets of soft glass or ceramic material that can be damaged by mechanical contact. For instance, low friction motion stages use air bearings 250 to support heavy loads on a thin layer of flowing air. Depending on the needs of the process, gases other than air, such as nitrogen, helium, or argon, may be used instead. Even though the following discussion refers to “air bearings,” it is applicable to structures with a different gas.

Air bearings 250 may be assembled from porous materials that are extruded or machined to a shape that closely matches the material they will support. An example is a U-shaped air bearing 250 for supporting hot ceramic ribbon material during high temperature processing. The U-shaped air bearing 250 is fabricated from porous extruded ceramic material, such as porous SiC. In some instances, such as shown in FIG. 25, a manifold channel 255 can be formed at the bottom of the extruded U-shape to distribute process gas (e.g., He) along the length of the air bearing 250. Since the air bearing 250 is used in a high temperature furnace for ceramic processing (e.g., >1400° C.), many traditional sealing materials (including organic and inorganic sealing solutions) are not available for sealing its exterior surface. This results in excessive loss of gas from the U-shaped air bearing 250, increasing processing cost if it cannot be recovered and recycled.

Referring now to FIG. 26, air bearings 250 can be fabricated with porous regions 165 and non-porous regions 190 to prevent or reduce excessive loss of air bearing gas. For instance, an internal manifold channel 255 may be extended up the vertical sides of the U-shaped air bearing 250, and it may also include a cover 260 to prevent excessive loss of air bearing 250 process gas to the environment. Since this design prevents the loss of process gas through the sidewalls of the U-shape, the flow rate of process gas can be reduced, reducing operating cost when expensive gases like helium and argon are used.

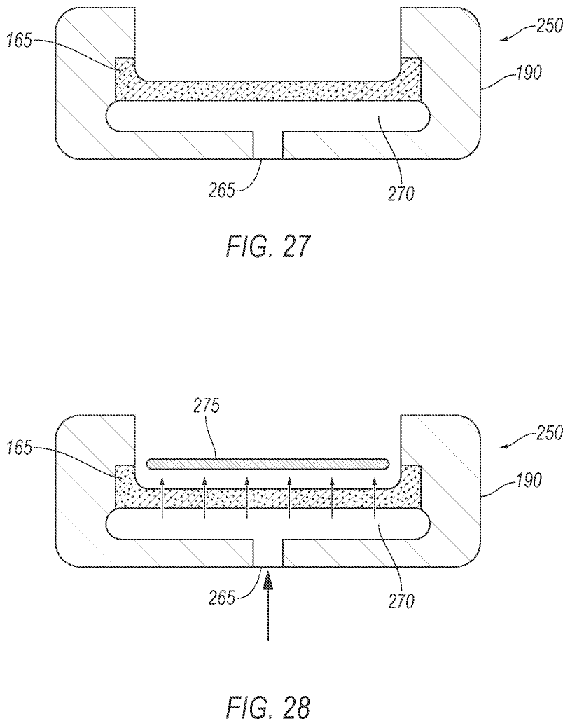

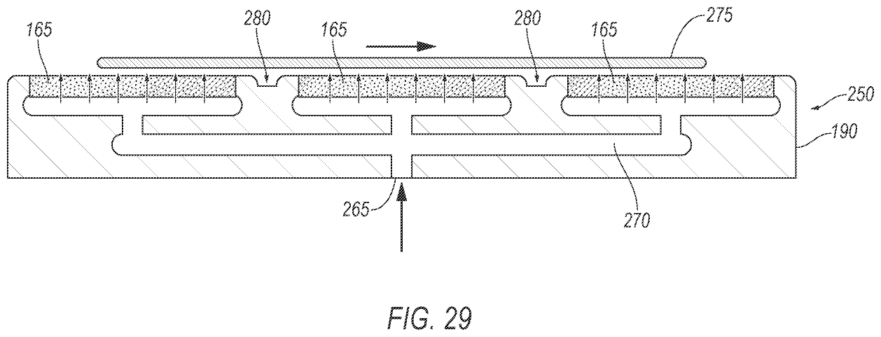

FIG. 27 illustrates an example cross-sectional view of a U-shaped air bearing 250 with porous regions 165, non-porous regions 190, and an air inlet 265. In some instances, as shown in FIGS. 27-29, the air inlet 265 may be integrated into a bottom surface of the air bearing 250. When in use, as shown in FIGS. 28-29, the process gas may flow into the air bearing 250 along the air manifold channel 270 and through the porous material at an inside bottom of, e.g., a U-shaped air bearing 250 to suspend a molten ribbon 275 of glass or ceramic materials. With reference to FIG. 29, air bearings 250 with porous and non-porous regions can also be used to transport molten sheets of material on a cushion of air or process gas. In that example implementation, a top surface of the air bearing 250 may include molded depressions 280 that form channels for gas to flow away from the sheet during processing. The lost material fabrication approach discussed above enables fabrication of these external channel features along with internal channels and porous regions 165 surrounded by non-porous ceramic material 190.

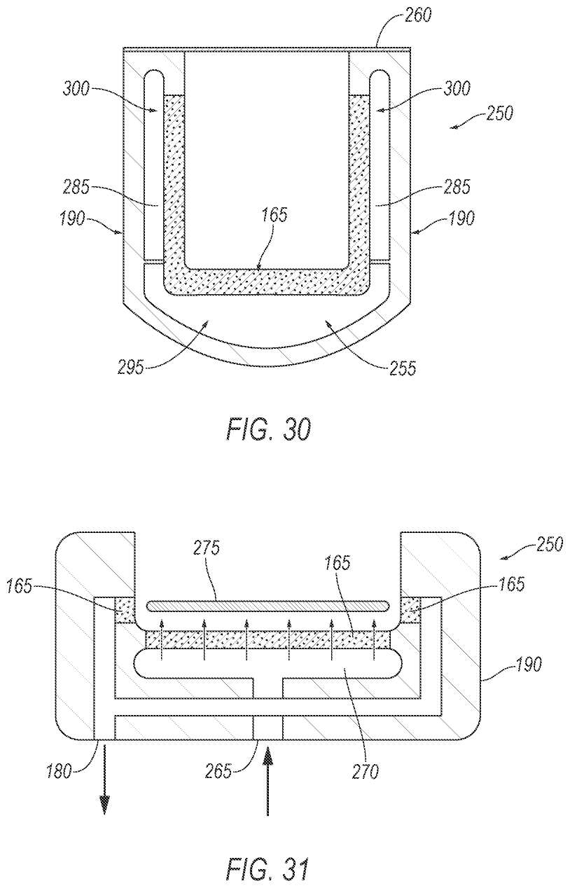

In some possible implementations, shown in FIG. 30, air bearings 250 can be provided with additional internal channels and features to enable process gas recapture. For instance, one internal channel may supply process gas to the porous inside bottom surface of the U-shaped air bearing 250 while two internal side channels 285 in the vertical portions of the U-shaped air bearing 250 may be operated under vacuum to collect used process gas from the interior of the U-shaped air bearing 250. In this example approach, inside vertical walls of the U-shaped air bearing 250 are porous while the outside vertical walls are non-porous. As before, a cover 260 on top of the U-shape may help prevent excessive escape of process gas. Moreover, internal walls 290 may separate a pressurized region 295 from the vacuum regions 300.

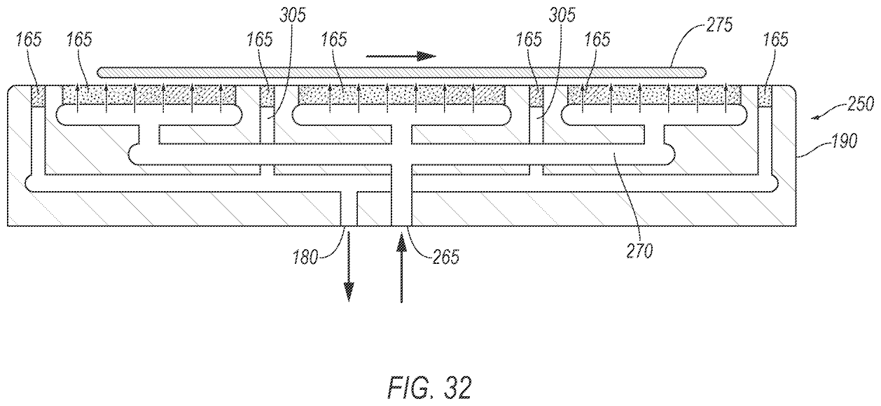

With reference to FIG. 31, the porous regions 165 located on the inside horizontal and vertical surfaces of the U-shaped air bearing 250 can be separated from each other by non-porous regions. This prevents or reduces the amount of process gas that leaks directly from the manifold channel to the process gas capture channel 305, increasing the amount of process gas available to levitate the molten ribbon 275. As shown in FIG. 32, process gas recapture can also be provided for an air bearing 250 that is used to transport molten sheets of material. In this example implementation, the surface exit channels may be replaced with porous surface regions that are connected to internal channels that enable process gas capture through gas capture channels 305.

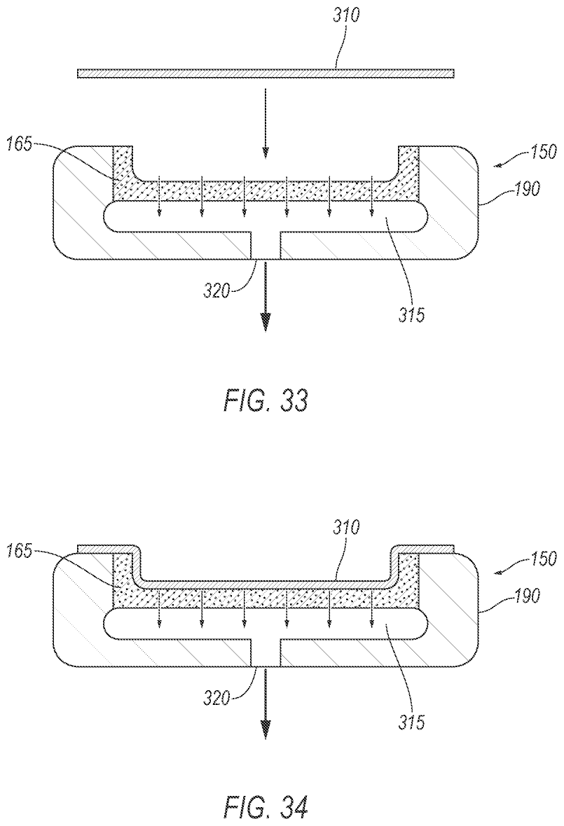

Turning now to implementations involving porous molds, and FIGS. 33-35, porous ceramic surfaces with precision flat or complex arbitrarily shaped profiles can be formed using the lost material forming process described above. These porous surfaces can be used to form glass sheets with complex 3D shapes via vacuum forming of heated glass sheets. For instance, a glass sheet 310 may be positioned over a heated mold having a, e.g., bathtub depression shape. The mold includes an internal air manifold 315 that can be used to either draw a vacuum on the topside porous surface, or to apply air pressure to the surface. The mold exterior sidewalls and bottom may be formed using non-porous ceramic materials 190.

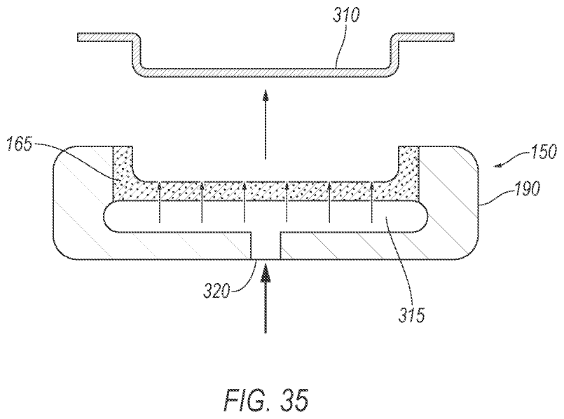

In the example of a porous mold shown in FIG. 34, the heated glass sheet 310 may be lowered onto the top surface of the mold, and then the vacuum forces may pull the glass sheet 310 into contact with the porous region 165 of the mold. This approach does not leave artifacts in the molded glass sheet 310 from vacuum ports on the top surface. Also, if needed, the porosity of the mold can be varied across the top surface, allowing the amount of vacuum force to be fine-tuned as needed in specific areas. This can help provide fine resolution or high aspect ratio features locally on a molded part. The porosity of the porous region 165 can be selected to be small (e.g., micrometer or submicrometer size) to ensure that smooth surfaces are formed on the molded glass part. As shown in FIG. 35, after molding, the glass sheet 310 may be ejected by applying air pressure to a bottom port 320.

Since the ceramic mold can also include additional independent channels, it is possible to provide additional channels or porous regions that help manage the temperature of the mold during the molding process. For example, channels can be provided to either rapidly heat or rapidly cool the mold from the interior. Rapid heating could be provided by channels that guide heated liquid metals through the ceramic body, while rapid cooling can be achieved by flowing air or water through channels. Internal channels can also enable non-uniform heating of the mold, enabling different glass viscosities at different locations, to enhance deformation and flow of the glass sheet 310 in specific regions as needed.

The example shown and described with reference to FIGS. 33-35 includes a shaped porous mold. The porous surface may be flat, however, in other molding applications. For example, the flat bottom surface of the U-shaped air bearing 250 can be use in alternation to support the ceramic ribbon in transport by supplying process air, to mold the ceramic ribbon flat by, e.g., providing a vacuum that pulls the ceramic ribbon into contact with the flat bottom surface of the U-shaped air bearing 250, etc.

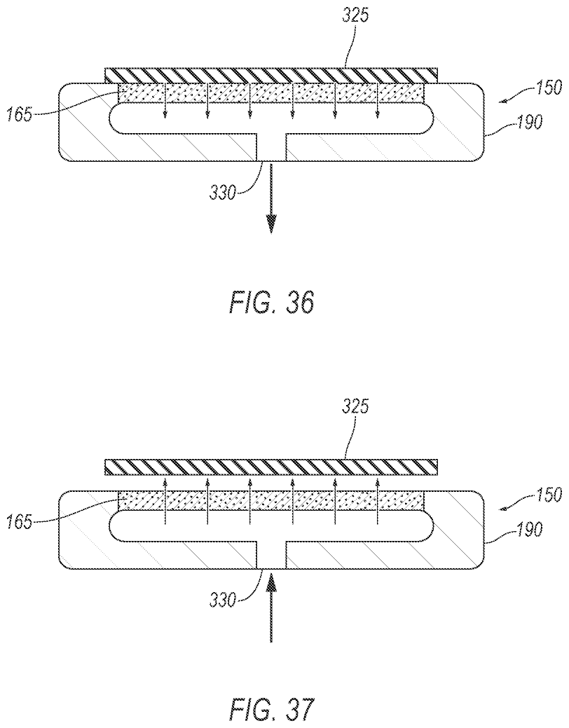

With reference now to FIGS. 36-37, wafer handlers may be used in semiconductor wafer processing to support and retain wafers 325 as they are transferred between various processing equipment stations. Wafer handlers made from ceramic materials are also well-suited to support wafers 325 during specific high temperature processes, such as Rapid Thermal Annealing (RTA). In RTA applications, wafers 325 are rapidly heated to high temperatures (e.g., >1000° C.) over a short period of time (e.g., 5-10 seconds). Ceramic wafer handlers can withstand such temperatures. Ceramic materials can be selected to have low CTE (Coefficient of Thermal Expansion) values that are a close match to silicon and III-V material wafers used in semiconductor processing. Ceramic wafer handlers also offer stability between atmospheric and vacuum operations. Similar wafer handlers constructed of plastics can suffer dimensional changes and shape change during vacuum processing, resulting in added stresses to the semiconductor wafers 325 and possible breakage.

An example cross-section view of a wafer handler based on pressed ceramic materials with porous and non-porous regions, as well as internal channels, is shown in FIG. 36. A top surface of the porous material 165 can be machined flat, either through grinding after firing or surface machining after debinding or partial firing. The top surface could also be grooved or offer raised pads to limit contact with the wafer 325. In a raised pad approach, the sides of the pads may be constructed of non-porous material to reduce vacuum leakage. A vacuum is provided at the bottom surface port 330 that causes the wafer 325 to be pulled into contact with the porous material at the top surface. As shown in FIG. 37, to remove the wafer 325 from the wafer carrier, air is applied at the bottom surface port 330.

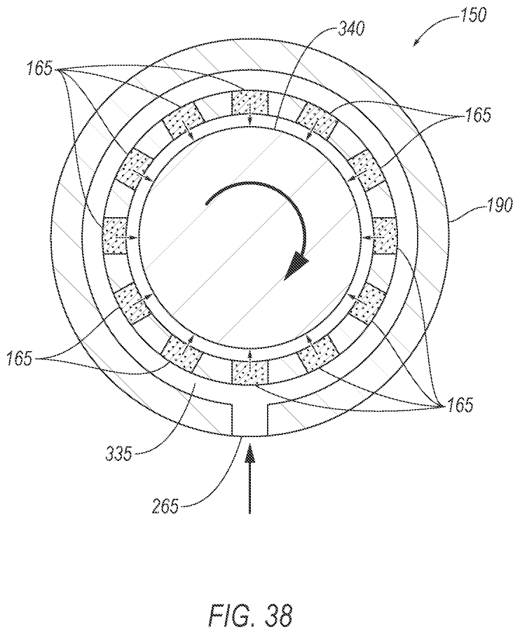

FIG. 38 illustrates an example approach for rotating bearings. Rotating bearings are commonly permanently lubricated with lubricants in a sealed packaging enclosure. In high heat applications, lubricating oils may not survive. Alternative solutions may include porous bearing materials that provide continuous replacement of lubricant slowly over time or air bearings that use porous bearing materials to suspect rotating shafts on a thin layer of air. Bearings operated at cryogenic temperatures may also have issues using liquid lubricants. In this case, air-lubricated bearings supplied through porous materials are a potential solution. Air lubricated bearings can also be important for precise centering of rotating shafts in precision machining equipment. An example rotating shaft air bearing that uses porous and non-porous materials is shown in FIG. 38. In this example approach, an internal air manifold channel 335 delivers air to porous material regions 165 that are distributed around the shaft 340. In this example, the porous regions 165 are provided at discrete locations around the shaft 340, while in other cases the shaft 340 could be surrounded by porous material.

Other features can also be incorporated into the air lubricated bearing, such as internal channels for heating the air bearing or keeping it cool. Precision internal bore surfaces of the air bearing can be initially formed through the lost material molding process. For precision applications, an additional grinding and/or diamond polishing step may be performed to give the porous material an extremely smooth finish with a precision profile.

The foregoing concept can be applied to various mechanical structures. Beams, for instance, are used in various applications to provide mechanical support and stiffness, often while minimizing weight and total cost of material. The flexure strength of a beam is proportional to the beam's area moment of inertia, and the beam's moment of inertia increases as more of its mass is moved away from its axis of rotation. Consider the shape of an I-beam (I) that is designed to resist flexure about the horizontal axis. The upper and lower flanges are enlarged and moved as far as possible from the midline to maximize strength and minimize weight. Details of the calculation are described as follows: For a beam extending in the Z direction with a cross-sectional area in the XY plane, the area moment of inertia about the X axis is calculated as Ix=∫y² dA while the area moment of inertia about the Y axis is calculated as Iy=∫x² dA. For this calculation the origin of the XY plane is centered on the centroid of the beam (i.e., the area center of mass). High strength configurations for beams are also revealed in nature. An example is the design of bones, such as the human. A thin layer of dense material around the exterior of the bone surrounds more porous material that fills the interior. The design is optimized to support loads placed along the axis of the bone: The thickness of the thin surface layer of dense material varies continuously along the length of the bone, and the structure of the interior porous material is optimized to provide high strength near load-bearing regions at the two ends of the bone.

The lost material process described above provides a unique ability to fabricate solid bodies with various complex regions of porous and non-porous materials. This approach can be applied to a variety of applications that utilize maximization of flexure strength and minimization of weight. Examples include ceramic bone replacement parts, mirrors and mirror supports for aerospace and defense applications, and lightweight ceramic components for high-end bicycles.

Using mirror supports as an example, an example of ceramic mirror lightweighting using porous and non-porous materials may include constructing mirror supports having vertical webs that have been lightweighted by making their central regions porous. In this example implementation, the porosity is in the center of the web, but in an alternative approach, the entire web could be made of porous material. Using porosity to increase the flexure strength of the mirror blank means the mirror can be employed without changing the width of the web features. For comparison, consider the I-beam cross-section which varies in width where the flanges project horizontally. Horizontal projections in a mirror, however, make it more difficult to mold and release the mirror features. The thin cantilever flange regions can also easily chip in machining and be damaged in handling of green mirror blank parts. The material that forms the mirror front face can also be lightweighted by forming it with porous and non-porous regions.

As discussed above, complex internal porous structures can be formed by engineering the ceramic material particle size distribution (PSD) as well as the size and shape of pore forming materials. For example, ceramic foams can be fabricated by allowing SiC powder to flow in between interstitial regions formed when wax spheres are packed together. Pore forming elements can also be elongated into ellipsoids and other shapes that self-orient during packing to create oriented internal structures. This concept can be used to create complex porous bone structures using complex internal porosity formed by 3D printing of solid material. Wax void forms can also be fabricated using 3D printing techniques to create complex void shapes. One difference regarding 3D printing of wax void forms is that, in order to create a single-body lost wax form, the printed structure should include interconnections between void regions. Sometimes, this void interconnection appears naturally as a consequence of the optimization process. The unfilled regions of the wax void form will later be filled with ceramic material. Given the complexity of the internal paths that remain through the wax void form, the voids may be filled with a ceramic slurry via, e.g., hydrostatic pressure or applying a vacuum. After pressing the ceramic slurry material densities, while after demolding, the wax void form is removed, leaving a complex internal porous network.

Another potential application involves porous burners. Burners with premixed combustion gases (e.g., natural gas and air) utilize a porous flame barrier to prevent the flame from travelling down inside the burner to the location where combustion gases first meet. An example is the cloth wick on a gas lantern that is ashed to prevent flame propagation to the gas mixing location inside the lantern. Another example may include a porous ceramic plate used in a space heater burner. The approach described herein enables distribution of the combustion flame across a broad area, improving direct radiation heat transfer to the intended object that should be heated or illuminated.

One advantage of the lost material process for burners is that porous burners could be fabricated from a single ceramic body that includes porous and non-porous regions, as well as internal channels for gas flow, combustion mixing, or both. This may help avoid problems with sealing of the dissimilar materials, as well as cracks and gaps that could be formed due to a coefficient of thermal expansion (CTE) mismatch of materials and/or extreme use temperatures or cold lightoff conditions.

In this example implementation, the burner face may include multiple layers with different combustion and mechanical support functions. These layers may be implemented in a monolithic body with different material properties (e.g., porosity, strength, conventional triaxial compression (CTC), etc.) determined by the specific materials and channel forms 115 used, as discussed above. More complex burner designs with multiple internal channels for integrated cooling and shroud gas delivery may also be implemented using the foregoing processes. In that case, features may be fabricated in a monolithic burner using the lost material process and its ability to create porous and non-porous regions within ceramic bodies.

Such burners may include a porous sintered burner plate/plug which is available in either bronze or stainless steel. The porous sintered plug may be 6 cm in diameter and may contain an Archimedean spiral cooling circuit for water/coolant flow. The cooling circuit may minimize radial temperature gradients. Moreover, the water-cooled porous plate may be pressed into a stainless steel housing which is then screwed into the main-body. A coaxial sintered bronze shroud may be fixed over the housing onto the main body. The fuel mixture (which may include pre-mixed oxidizer and fuel) may be introduced through a ¼ inch compression fitting into the bottom of the housing and distributed evenly through the sintered matrix plug. A pressure surge in the fuel flow may be normalized in the cavity located below the sintered plug within the housing. Likewise, the shroud ring's inert gas may be introduced through a ¼ inch compression fitting into a chamber in the main-body.

In some instances, combustion gases may be mixed at the burner face to produce a long, large flame that extends into the region that should be heated. Examples include oxy-fuel burners used to heat glass in large glass melt tanks, where the flame projects over the surface of the glass, and submerged combustion melting, where the burner projects into the glass melt tank from below. Submerged combustion melting provides intense heat-transfer and mixing between the submerged flame jet and melt tank glass. While burners that provide mixing at the burner face do not necessarily require porous regions, they can be added to help manage thermal gradients at the burner face, or as an added guard against flame or foreign body intrusion into the burner.

In a combustion reactor, gases are mixed and combusted within an enclosure to capture heat and/or produce specific chemical byproducts. An example reaction is partial oxidation of hydrogen through steam reforming (typically implemented as methane steam reforming (MSR)). In one possible implementation, combustion gases are introduced into a base cavity where they initially mix. Mixing is enhanced as the gases flow through side orifice openings in a central mixer, and through a porous flame barrier. A flame is produced inside the reactor, and heat is transferred to a nearby ceramic sleeve that is insulated from its surroundings Ports on the side of the reaction chamber enable introduction of other reactants (e.g., steam). Features of this reactor could be fabricated in a monolith ceramic body using the lost material process disclosed above, including porous and non-porous internal regions and internal channels for introducing reactants, routing them through the reactor, and removing them from the reactor. With the lost material process, the finished reactor has no internal joints that can leak, or junctions between dissimilar materials that could lead to cracks and leaks due to CTE mismatch and/or thermal gradients.

Porous burners can also be employed in combustion reactors that include internal heat exchange and reactant gas preheating. In one example, the combustion chamber includes a porous flame barrier and integrated heat exchange. In another example, a spiral channel configuration enables preheating of reactant gases as they spiral inward to a central combustion chamber using excess heat from combustion products as they spiral outward from the combustion chamber auto-thermal chemical reaction. Features of this reactor could be fabricated in a monolith ceramic body using the lost material process, including porous and non-porous internal regions and internal channels for introducing reactants, routing them through the reactor, and removing them from the reactor. Instead of fabricating the reactor from dissimilar materials, all features could be formed in a unified body, eliminating mechanical interfaces that are prone to leak in operation, often with catastrophic results as flames progress to portions of the reactor where they were not designed to be.

Fuel cells, which can also be manufactured using the foregoing processes, present unique ceramic packaging challenges because they integrate chemical reactions and electrically conductive materials in a high temperature environment that is subject to wide temperature swings and thermal gradients. Fuel cells are typically constructed through hybrid integration of a variety of metallic and ceramic materials. The lost material process may be used to produce dense ceramic bodies with internal channels and locally porous regions during fabrication of a portion or all of a fuel cell assembly.

Metal filtration is another concept that benefits from the foregoing lost material process. Metal filtration is performed immediately prior to metal casting to ensure that finished castings are free of particulate impurities that could lead to defects and product failures. Metal filters are often fabricated from extruded metal honeycombs. The lost material process could produce the fine features with controlled porosity that enable filtration and enable integrated solutions that combine other functions (e.g., metal mixing of alloys immediately in advance of casting) and heat exchange.

Another use of the lost material process includes manufacture of disc brakes. Disc brakes are subject to high-heat situations and should remain stiff and flat to perform adequately. Disc brake rotors for some vehicles, particularly high-end sports cars and race cars, should withstand extremely high-heat applications while remaining light-weight. Ceramic brake rotors are attractive for their strength to weight ratio and their ability to withstand high temperatures. The lost material process could produce ceramic rotors with internal porous channels or layers for ventilation to reduce the operating temperature of the disc brakes and limit wear on the brake pads. These porous channels are stronger than hollow channels and reduce shape deformation of the rotors, extending their lifetime and effectiveness.

A first aspect of the present disclosure relates to a process for forming a fluidic module with integrated fluid separation includes positioning a first positive passage mold of a first fluid passage having a tortuous shape within a volume of binder-coated ceramic powder, positioning a second positive passage mold of a second fluid passage having a tortuous shape within the volume of ceramic powder and spaced apart from the first positive passage mold, positioning a powder interconnect adjacent to a portion of each of the first and second positive passage molds within the volume of ceramic powder, pressing the volume of ceramic powder with the first and second positive passage molds and the powder interconnect inside to form a pressed body, heating the pressed body to remove the first and second positive passage molds, and sintering the pressed body to form a closed-porosity ceramic body. The closed-porosity ceramic body includes respective first and second tortuous fluid passages extending therethrough and an open-porosity ceramic region fluidically connecting the first and second tortuous fluid passages, the open-porosity ceramic region corresponding to the powder interconnect.

A second aspect of the present disclosure includes a process according to the first aspect, wherein positioning a powder interconnect adjacent to portions of the first and second positive passage molds includes depositing a volume of porous ceramic powder between the first and second positive passage molds before pressing.

A third aspect of the present disclosure includes a process according to the first aspect, further including inserting a wall structure prior to depositing the volume of porous ceramic powder, the wall structure configured to retain the deposited volume of porous ceramic powder in a predetermined region, and removing the wall structure after depositing the volume of porous ceramic powder.

A fourth aspect of the present disclosure includes a process according to the third aspect, wherein removing the wall structure includes one or more of heating and sintering the pressed body.

A fifth aspect of the present disclosure includes a process according to the first aspect, wherein positioning a powder interconnect adjacent to portions of the first and second positive passage molds includes positioning an interconnect mold between the first and second positive passage molds before pressing, the interconnect mold highly filled with ceramic particles.

A sixth aspect of the present disclosure includes a process according to the fifth aspect, wherein heating the pressed body includes removing a mold material portion of the interconnect mold and leaving a self-supporting matrix of the ceramic particles.

A seventh aspect of the present disclosure includes a process according to the fifth aspect, wherein the interconnect mold is joined to at least one of the first and second positive passage molds before being positioned within the volume of ceramic powder.

An eighth aspect of the present disclosure includes a process according to the seventh aspect, wherein the interconnect mold is joined to the at least one of the first and second positive passage molds by local heating of corresponding surfaces to be joined.

A ninth aspect of the present disclosure includes a process according to the seventh aspect, wherein the interconnect mold is joined to the at least one of the first and second positive passage molds by forming corresponding engagement feature in the molds.

A tenth aspect of the present disclosure includes a process according to the fifth aspect, wherein the interconnect mold is molded concurrently with at least one of the first and second positive passage molds before being positioned within the volume of ceramic powder.

An eleventh aspect of the present disclosure includes a process according to the first aspect, wherein positioning a powder interconnect adjacent to portions of the first and second positive passage molds includes applying an interconnect paste between the first and second positive passage molds before pressing, the interconnect paste highly filled with ceramic particles.

A twelfth aspect of the present disclosure includes a process according to the first aspect, wherein positioning a powder interconnect adjacent to portions of the first and second positive passage molds includes positioning a plurality of powder interconnects between the first and second positive passage molds before pressing, each of the powder interconnects configured to form a different open-porosity ceramic region after sintering.

A thirteenth aspect of the present disclosure relates to a process for forming a fluidic module with integrated temperature regulation, the process including positioning a first positive passage mold of a first fluid passage having a tortuous shape within a volume of binder-coated ceramic powder, positioning a second positive passage mold of a second fluid passage having a tortuous shape within the volume of ceramic powder and spaced apart from the first positive passage mold, a length of the second positive passage mold highly filled with ceramic particles, pressing the volume of ceramic powder with the first and second positive passage molds inside to form a pressed body, heating the pressed body to remove the first and second positive passage molds and leave a self-supporting matrix of the ceramic particles, and sintering the pressed body to form a closed-porosity ceramic body having respective first and second tortuous fluid passages extending therethrough, the second tortuous fluid passage including an open-porosity ceramic region that occupies a volume of the second tortuous fluid passage along the length.

A fourteenth aspect of the present disclosure relates to a fluidic module for a flow reactor including a monolithic closed porosity ceramic body, at least one tortuous fluid passage extending through the ceramic body, and at least one open-porosity ceramic region defining a portion of the at least one tortuous fluid passage.

A fifteenth aspect of the present disclosure includes a fluidic module according to the fourteenth aspect, wherein the at least one tortuous fluid passage includes at least two tortuous fluid passages extending through the ceramic body and spaced apart from one another, the open-porosity ceramic region occupying a volume of the second tortuous fluid passage along a length of the second tortuous fluid passage.

A sixteenth aspect of the present disclosure includes a fluidic module according to the fourteenth aspect, wherein the at least one tortuous fluid passage includes at least two tortuous fluid passages extending through the ceramic body and spaced apart from one another, the at least one open-porosity ceramic region defining respective interior surface portions of each of the first and second tortuous fluid passages.

A seventeenth aspect of the present disclosure includes a fluidic module according to the sixteenth aspect, wherein respective paths of the at least two tortuous fluid passages lie substantially in a plane oriented parallel to opposing major surfaces of the ceramic body.

An eighteenth aspect of the present disclosure includes a fluidic module according to the seventeenth aspect, wherein at least one of the tortuous fluid passages is spaced apart on each side of the other of the tortuous fluid passages within the plane, the at least one open-porosity ceramic region defining opposed lateral interior surface portions of the other of the tortuous fluid passages.

A nineteenth aspect of the present disclosure includes a fluidic module according to the sixteenth aspect, wherein respective paths of the at least two tortuous fluid passages lie substantially in respective planes spaced part in a direction normal to opposing major surfaces of the ceramic body.

A twentieth aspect of the present disclosure includes a fluidic module according to the sixteenth aspect, wherein the at least two tortuous fluid passages include a first tortuous fluid passage and a plurality of second tortuous fluid passages each spaced apart from the first tortuous passage and the at least one open-porosity ceramic region includes a plurality of open-porosity ceramic regions each defining interior surface portions of the first tortuous fluid passage and respective interior surface portions of the plurality of second tortuous fluid passages.

A twenty-first aspect of the present disclosure includes a fluidic module according to the sixteenth aspect, wherein the at least one open-porosity ceramic region includes a plurality of open-porosity ceramic regions serially arranged between the at least two tortuous fluid passages, each open-porosity ceramic region defining a different porosity characteristic.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A process for forming a fluidic module with integrated fluid separation, comprising:
positioning a first positive passage mold of a first fluid passage having a tortuous shape within a volume of binder-coated ceramic powder;
positioning a second positive passage mold of a second fluid passage having a tortuous shape within the volume of ceramic powder and spaced apart from the first positive passage mold;
positioning a powder interconnect adjacent to a portion of each of the first and second positive passage molds within the volume of ceramic powder;
pressing the volume of ceramic powder with the first and second positive passage molds and the powder interconnect inside to form a pressed body;
heating the pressed body to remove the first and second positive passage molds; and
sintering the pressed body to form a closed-porosity ceramic body having:
respective first and second tortuous fluid passages extending therethrough, and
an open-porosity ceramic region fluidically connecting the first and second tortuous fluid passages, the open-porosity ceramic region corresponding to the powder interconnect.

2. The process of claim 1, wherein positioning a powder interconnect adjacent to portions of the first and second positive passage molds includes depositing a volume of porous ceramic powder between the first and second positive passage molds before pressing.

3. The process of claim 2, further comprising:
inserting a wall structure prior to depositing the volume of porous ceramic powder, the wall structure configured to retain the deposited volume of porous ceramic powder in a predetermined region; and
removing the wall structure after depositing the volume of porous ceramic powder.

4. (canceled)

5. The process of claim 1, wherein positioning a powder interconnect adjacent to portions of the first and second positive passage molds includes positioning an interconnect mold between the first and second positive passage molds before pressing, the interconnect mold highly filled with ceramic particles.

6. The process of claim 5, wherein heating the pressed body includes removing a mold material portion of the interconnect mold and leaving a self-supporting matrix of the ceramic particles.

7. The process of claim 5, wherein the interconnect mold is joined to at least one of the first and second positive passage molds before being positioned within the volume of ceramic powder.

8. The process of claim 7, wherein the interconnect mold is joined to the at least one of the first and second positive passage molds by local heating of corresponding surfaces to be joined.

9. The process of claim 7, wherein the interconnect mold is joined to the at least one of the first and second positive passage molds by forming corresponding engagement feature in the molds.

10. The process of claim 5, wherein the interconnect mold is molded concurrently with at least one of the first and second positive passage molds before being positioned within the volume of ceramic powder.

11. The process of claim 1, wherein positioning a powder interconnect adjacent to portions of the first and second positive passage molds includes applying an interconnect paste between the first and second positive passage molds before pressing, the interconnect paste highly filled with ceramic particles.

12. The process of claim 1, wherein positioning a powder interconnect adjacent to portions of the first and second positive passage molds includes positioning a plurality of powder interconnects between the first and second positive passage molds before pressing, each of the powder interconnects configured to form a different open-porosity ceramic region after sintering.

13. A process for forming a fluidic module with integrated temperature regulation, comprising:
positioning a first positive passage mold of a first fluid passage having a tortuous shape within a volume of binder-coated ceramic powder;
positioning a second positive passage mold of a second fluid passage having a tortuous shape within the volume of ceramic powder and spaced apart from the first positive passage mold, a length of the second positive passage mold highly filled with ceramic particles;
pressing the volume of ceramic powder with the first and second positive passage molds inside to form a pressed body;
heating the pressed body to remove the first and second positive passage molds and leave a self-supporting matrix of the ceramic particles; and
sintering the pressed body to form a closed-porosity ceramic body having respective first and second tortuous fluid passages extending therethrough, the second tortuous fluid passage including an open-porosity ceramic region that occupies a volume of the second tortuous fluid passage along the length.

14. A fluidic module for a flow reactor, comprising:
a monolithic closed porosity ceramic body;
at least one tortuous fluid passage extending through the ceramic body; and
at least one open-porosity ceramic region defining a portion of the at least one tortuous fluid passage.

15. The fluidic module of claim 14, wherein the at least one tortuous fluid passage includes at least two tortuous fluid passages extending through the ceramic body and spaced apart from one another, the open-porosity ceramic region occupying a volume of the second tortuous fluid passage along a length of the second tortuous fluid passage.

16. The fluidic module of claim 14, wherein the at least one tortuous fluid passage includes at least two tortuous fluid passages extending through the ceramic body and spaced apart from one another, the at least one open-porosity ceramic region defining respective interior surface portions of each of the first and second tortuous fluid passages.

17. The fluidic module of claim 16, wherein respective paths of the at least two tortuous fluid passages lie substantially in a plane oriented parallel to opposing major surfaces of the ceramic body.

18. The fluidic module of claim 17, wherein at least one of the tortuous fluid passages is spaced apart on each side of the other of the tortuous fluid passages within the plane, the at least one open-porosity ceramic region defining opposed lateral interior surface portions of the other of the tortuous fluid passages.

19. The fluidic module of claim 16, wherein respective paths of the at least two tortuous fluid passages lie substantially in respective planes spaced apart in a direction normal to opposing major surfaces of the ceramic body.

20. The fluidic module of claim 16, wherein:
the at least two tortuous fluid passages include a first tortuous fluid passage and a plurality of second tortuous fluid passages each spaced apart from the first tortuous passage, and
the at least one open-porosity ceramic region includes a plurality of open-porosity ceramic regions each defining interior surface portions of the first tortuous fluid passage and respective interior surface portions of the plurality of second tortuous fluid passages.

21. The fluidic module of claim 16, wherein the at least one open-porosity ceramic region includes a plurality of open-porosity ceramic regions serially arranged between the at least two tortuous fluid passages, each open-porosity ceramic region defining a different porosity characteristic.
